(19) United States
(12) Patent Application Publication
(10) Pub. No.: US 2005/0220995 A1
(43) Pub. Date: Oct. 6, 2005

(54) Cold gas-dynamic spraying of wear resistant alloys on turbine blades

(76) Inventors: Yiping Hu, Greer, SC (US); Federico Renteria, Greenville, SC (US); Murali Madhava, Gilbert, AZ (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/819,816

(22) Filed: Apr. 6, 2004

(51) Int. Cl. B05D 3/02

(52) U.S. Cl. 427/180; 427/372.2

(57) ABSTRACT

A new method for increasing the durability of a turbine engine is provided. The method utilizes a cold gas-dynamic spray technique to apply wear resistant materials to turbine blades. These wear resistant materials improve the durability of the turbine blades, and thus can improve the overall durability, reliability and performance of the turbine engine themselves. In the cold gas-dynamic spray process particles at a temperature below their fusing temperature are accelerated and directed to a target surface on the turbine blade. When the particles strike the target surface, the kinetic energy of the particles is converted into deformation of the particle, causing the particle to form a strong bond with the target surface. Post-spray processing is then performed to consolidate the coating materials and restore material properties in the turbine blade. Thus, the cold gas-dynamic spray process can apply a coating of wear resistant materials to the turbine blades.

### FIELD OF THE INVENTION

This invention generally relates to turbine engines, and more specifically relates to applying wear-resistant materials to turbine engine components such as the z-notches of turbine blades.

### BACKGROUND OF THE INVENTION

Turbine engines are used as the primary power source for aircraft, in the forms of jet engines and turboprop engines, as auxiliary power sources for driving air compressors, hydraulic pumps, etc, on aircraft, industrial gas turbine (IGT) power generation and as stationary power supplies such as backup electrical generators for hospitals and the like. The same basic power generation principles apply for all these types of turbine engines. Compressed air is mixed with fuel and burned, and the expanding hot combustion gases are directed against stationary turbine vanes in the engine. The vanes turn the high velocity gas flow partially sideways to impinge on the turbine blades mounted on a turbine disk or wheel that is free to rotate.

The force of the impinging gas causes the turbine disk to spin at high speed. Jet propulsion engines use this power to draw more air into the engine and the high velocity combustion gas is passed out of the aft end of the gas turbine, creating forward thrust. Other engines use this power to turn a propeller, electrical generator, or other devices.

The turbine blades are critical components in any turbine engine. During operation of the turbine engine, the turbine blades are subjected to high heat (often in excess of 1000 degrees C.) and stress loadings as they are rotated and impacted by the hot gas. This high heat and stress can result in unacceptably high rates of degradation (including erosion, oxidation, corrosion and thermal fatigue cracks) on the turbine blades, resulting in many cases in the need for repair and/or replacement, something that can result in significant expense and time out of service. Therefore, there is a continuing need to identify improvements to the construction techniques and/or design of the turbine blades to achieve higher performance and improved lifespan.

### BRIEF SUMMARY OF THE INVENTION

The present invention provides an improved method for increasing the durability of a turbine engine. The method utilizes a cold gas-dynamic spray technique to apply wear resistant materials to turbine blades and other turbine engine components, including high pressure turbine (HPT) components. These wear resistant materials improve the durability of the turbine blades, and thus can improve the overall durability, reliability and performance of the turbine engine themselves. In the cold gas-dynamic spray process powder materials at a temperature below their fusing temperature are accelerated and directed to a target surface on the turbine blade. When the powder materials strike the target surface, the kinetic energy of the powder materials is converted into plastic deformation of the particle, causing the materials to form a strong bond with the target surface. Thus, the cold gas-dynamic spray process can apply a coating of wear resistant materials to the turbine blades.

The cold gas-dynamic spray process can apply wear resistant materials that are difficult to apply using more conventional techniques. For example, the cold gas-dynamic spray process can be used to apply wear resistant alloys that in general are not easily welded. When these alloys are welded, cracks and other defects frequently result, requiring costly reworking and resulting in high rejection rates. In contrast, the cold gas-dynamic spray process can apply a coating of these wear resistant alloys without the problems associated with welding them.

In one specific embodiment, the cold gas-dynamic spray process is used to apply wear resistant coatings to the “z-notch” area of the turbine blades. The z-notch of the turbine blades is a portion of the shroud blade where adjacent turbine blades meet, and is thus subjected to increased wear. Applying the wear resistant coating to the z-notch area can increase the durability of the z-notch and the turbine blade in general.

### BRIEF DESCRIPTION OF DRAWINGS

The preferred exemplary embodiment of the present invention will hereinafter be described in conjunction with the appended drawings, where like designations denote like elements, and:

FIG. 1 is a schematic view of an exemplary cold gas-dynamic spray apparatus;

FIG. 2 is a perspective view of an exemplary turbine blade;

FIG. 3 is a top view of an exemplary turbine blade shroud structure having a z-notch edge shape;

FIG. 4 is a side view of a turbine blade shroud illustrating a z-notch edge; and

FIG. 5 is a flow diagram of a wear resistant coating method.

### DETAILED DESCRIPTION OF THE INVENTION

The present invention provides an improved method for increasing the durability of a turbine engine. The method utilizes a cold gas-dynamic spray technique to apply wear resistant materials to turbine blades. These wear resistant materials improve the durability of the turbine blades, and thus can improve the overall durability, reliability and performance of the turbine engine themselves.

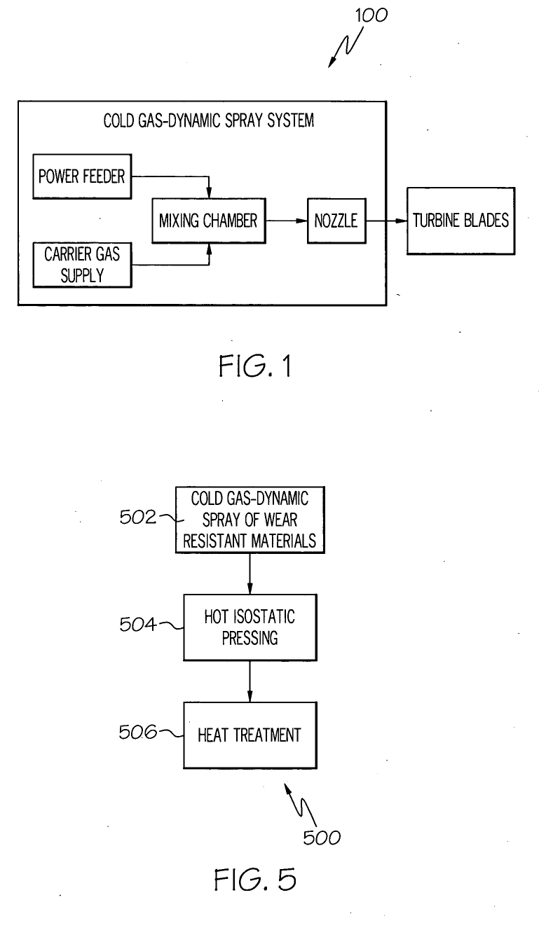

Turning now to FIG. 1, an exemplary cold gas-dynamic spray system 100 is illustrated schematically. The cold gas-dynamic spray system 100 is a simplified example of a type of system that can be used to apply a wear resistant coating on turbine blades. Those skilled in the art will recognize that most typical implementations of cold gas-dynamic spray systems would include additional features and components. The cold gas-dynamic spray system 100 includes a powder feeder of wear resistant coating powder materials, a carrier gas supply, a mixing chamber and a convergent-divergent nozzle or other forms of particle accelerating nozzles. In general, the system 100 mixes the wear resistant powder materials with a suitable pressurized gas in the mixing chamber. The materials are accelerated through the nozzle and directed toward a target surface on the turbine blade. When the materials strike the target surface, the kinetic energy of the materials is converted into plastic deformation of the particle, causing the materials to form a strong bond with the target surface. Thus, the cold gas-dynamic spray system 100 can apply a coating of wear resistant materials to the turbine blades.

The cold gas-dynamic spray process is referred to as a “cold spray” process because the materials are mixed and applied at a temperature that is well below the fusing or melting point of the particles. Thus, it is the kinetic energy of the materials on impact of with the target surface that causes the materials to deform and bond with the target surface, not the preexisting temperature of the materials themselves.

The cold gas-dynamic spray system 100 can apply wear resistant materials that are difficult to apply using more conventional techniques. For example, the cold gas-dynamic spray system 100 can be used to apply alloys that in general are not easily welded. When these types of alloys are welded, cracks and other defects frequently result, requiring costly reworking and resulting in high rejection rates. In contrast, the cold gas-dynamic spray system 100 can apply a coating of these wear resistant alloys without many of the problems associated with welding them.

A wide variety of different types of materials can be used to form the wear resistant coatings on the turbine blades. Examples of the type of wear resistant alloys that can be applied to turbine blades using a cold gas-dynamic spray process include Stellite694 and Tribaloy800 available from Stellite Coatings. Both these alloys have desirable wear resistance characteristics, but are difficult to apply using conventional welding techniques such as TIG and laser welding. Other examples of wear resistant materials that can be applied on high pressure turbine components with a cold gas-dynamic spray process are CM 64, Tribaloy 400 & 700, Chromium Carbides and Tungsten Carbides.

In one specific embodiment, the cold gas-dynamic spray process is used to apply wear resistant coatings to the “z-notch” area of the turbine blades. Turbine blades in contemporary engines often include a shroud with “z-notches” for application at the low pressure section of the turbine engine. The term z-notch refers to a configuration on the turbine blade shroud in the shape of a “z”. In these turbine engines, neighboring blades interlock at the z-notch areas. The z-notch provides the turbine blades with an additional degree of stiffness to offset the twisting forces that the turbine blades experience in operation. Z-notches can also provide counterbalance for harmful vibrations in the turbine blades.

Because the z-notches are points of contact between turbine blades, the interlocking faces can experience wear and erosion. Consequently, over a period of time in operation the z-notch wear surfaces of the turbine blades may need to be repaired or resurfaced. Thus it is desirable to apply hardfacing materials onto z-notch areas of new shroud blades in order to improve their wear resistance, and thus increase their operational lifespan and decrease the need for repairs and resurfacing.

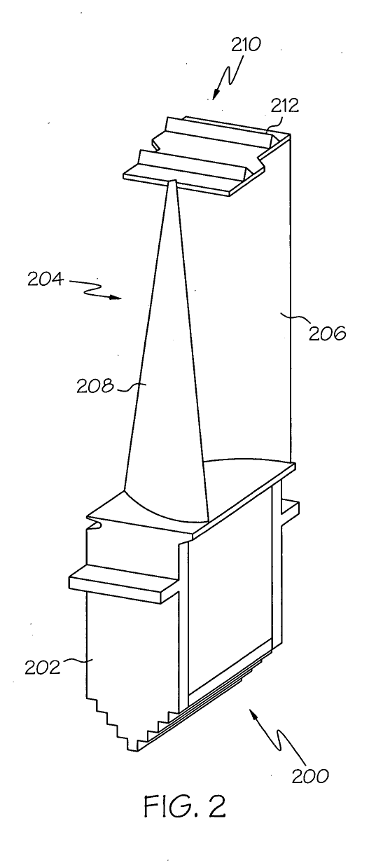

Turning now to FIG. 2, an exemplary turbine blade 200 is illustrated. Turbine blade 200 is exemplary of the type of turbine blades that are used in the turbine engines and is thus exemplary of the type of blade on which a wear resistant coating can be applied using the methods and processes of the present invention. In a typical turbine engine, multiple turbine blades 200 are positioned in adjacent circumferential position along a hub or rotor disk. The turbine blades are typically made from advanced superalloys such as IN713, IN738, IN792, MarM247, GTD111, Rene142, Rene N5, SC180 and CMSX4 to name several non-exclusive examples. These superalloys provide the high elevated-temperature strength needed for the blades, but also typically suffer from poor weldability due to the presence of high volume fraction of gamma prime strengthening phase.

The turbine blade 200 typically has a different shape, dimension and size depending on gas turbine engine models and applications. The turbine blade 200 includes a serrated base assembly 202 where the blade is affixed to a hub (not shown). The turbine blade 200 also includes an airfoil 204, a cup like pocket structure that is sometimes referred to as a bucket. The airfoil 204 includes a concave face 206 and a convex face 208. In operation, gases impinge on the concave face 206 of airfoil 204 thereby providing the driving force for the turbine engine.

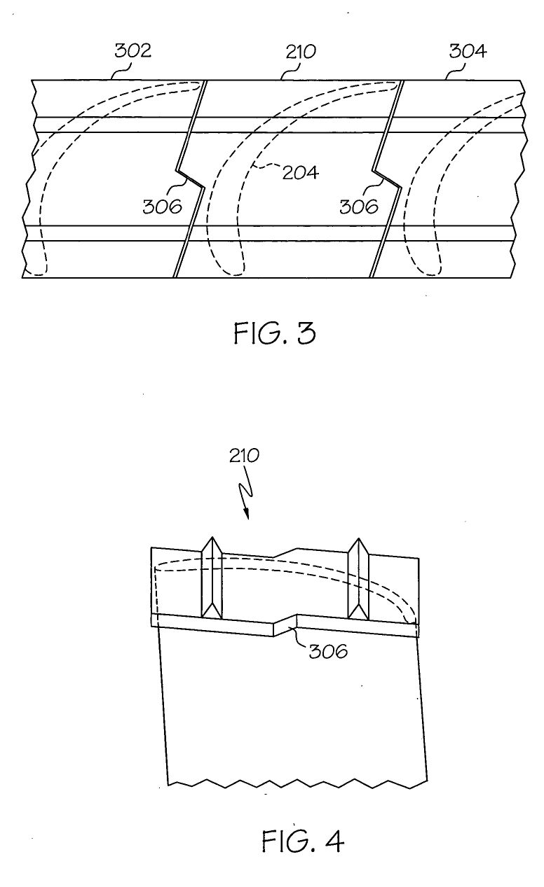

The turbine blade 200 also includes a shroud structure 210 at the upper or outer radial end of the turbine blade 200, with the shroud structure 210 including a knife seal 212. Turning now to FIG. 3, a top view of typical shroud structure 210 is illustrated along with portions of two adjacent shrouds 302 and 304. Shown in dashed outline is the airfoil 204. As illustrated in FIG. 3, the neighboring shrouds interlock using a z-notch configuration. Specifically, each shroud includes a z-notch edge shape 306 where neighboring blades interlock. The z-notch interlock provides the turbine blades with an additional degree of stiffness to offset the twisting forces that the blades experience during operation. The z-notches can also counterbalance harmful vibrations in the turbine blades and ensure that the blades are properly aligned. The interlocking shroud structure is additionally useful in preventing gases from avoiding the turbine blades.

Because the interlocking faces of the z-notches are points of contact between turbine blades these faces may experience wear and erosion during operation of the turbine engine. Turning now to FIG. 4, a side view of a turbine blade z-notch shroud 210 is illustrated. Again, this is just one example of a portion of the turbine blade that a wear resistant coating can be applied to. The turbine blade z-notch shroud 210 includes an edge 306. This edge 306 is particularly subject to wear due to contact with the z-notch shroud of the adjacent turbine blade. Using the cold gas-dynamic spray process, a wear resistant coating can be formed on the z-notch edge 306 to improve the wear resistance and durability of the z-notch edge 306. Of course, this is just one example of where wear on the turbine blade can occur, and the cold gas-dynamic spray process can be used to apply wear resistant coatings to other portions of the turbine blades. Furthermore, other components in a turbine engine can also be coated, including high pressure turbine components such as turbine blades in the high pressure stages.

As discussed above, a suitable cold gas-dynamic spray system typically includes a powder feed for transmitting wear resistant alloy, a carrier gas supply, a mixing chamber and a nozzle. The system mixes the wear resistant alloy particles with a suitable carrier gas in the mixing chamber. The particles are accelerated through the nozzle and directed toward a target surface on the turbine blade, such as the z-notch area of the turbine blade. When the particles strike the target surface, the kinetic energy of the particles is converted into plastic deformation of the particle, causing the particle to form a strong bond with the target surface. Thus, the cold gas-dynamic spray system can apply a coating of wear resistant materials to the turbine blades.

A variety of different systems and implementations can be used to perform the cold gas-dynamic spraying process. Cold gas-dynamic spray systems were originally developed at the Institute for Theoretical and Applied Mechanics of the Siberian Division of the Russian Academy of Science in Novosibrisk. The cold gas-dynamic spray process developed there was described in U.S. Pat. No. 5,302,414, entitled “Gas-Dynamic Spraying Method for Applying a Coating”. This patent describes an exemplary system designed to accelerate materials having a particle size of between 5 to about 50 microns, to be mixed with a process gas to ensure a density of mass flow rate of the particles 0.05 and 17 g/s-cm2 in the system. Supersonic velocity is imparted to the gas flow, with the jet formed at high density and low temperature using a predetermined profile. The resulting gas and powder mixture is introduced into the supersonic jet to impart sufficient acceleration to ensure a velocity of the particles ranging from 300 to 1200 m/s. In this method, the particles are applied and deposited in the solid state, i.e., at a temperature which is considerably lower than the melting point of the powder material. The resulting coating is formed by the impact and kinetic energy of the particles which gets converted to high-speed plastic deformation, causing the particles to bond to the surface. The system typically uses gas pressures of between 5 and 20 atm, and at a temperature of up to 750 degrees F. As non limiting examples, the gases can comprise air, nitrogen, helium and mixtures thereof. Again, this system is but one example of the type of system that can be adapted to cold spray powder materials to the target surface.

Turning now to FIG. 5, an exemplary method 500 for forming a wear resistant coating on turbine blades is illustrated. This method uses a cold gas-dynamic spray process to apply the wear resistant coating but also includes additional processing to improve wear resistant coating and resulting turbine blade. As described above, cold gas-dynamic spray involves “solid state” processes to effect bonding and coating build-up, and does not rely on thermal energy to improve bonding. Unfortunately, this can result in the developed microstructures of the material not exhibiting the desired structures and phase distributions to produce the desired properties. Also, the coating materials applied by cold gas-dynamic spray are more likely to exhibit lack of metallurgical bonding between the splats and as a consequence many thermo-mechanical properties such as the elastic/plastic properties, mechanical properties, thermal conductivity and thermal expansion properties are not likely to be at desired levels. Hence, for the coating of turbine blades additional processing is generally necessary to restore these desired properties. In method 500, this additional processing includes a hot isostatic pressing and heat treatment. These processing steps are designed to consolidate and homogenize the cold gas-dynamic spray applied wear-resistant material and to restore metallurgical integrity to the coated turbine blade.

The first step 502 is to perform a cold gas-dynamic spray of wear resistant materials on the turbine blade. As described above, in cold gas-dynamic spraying, particles at a temperature below their fusing temperature are accelerated and directed to a target surface on the turbine blade. When the particles strike the target surface, the kinetic energy of the particles is converted into plastic deformation of the particle, causing the particle to form a strong bond with the target surface.

As described above, this step can include the application of wear resistant coating material to a variety of different parts on the turbine blade. For example, it can be used to apply material to the shroud structure in general, and the z-notch shape edge of the shroud in particular. The thickness of the applied coating would depend upon the application. For example, on a z-notch coating one exemplary desired final thickness would be between 0.006 and 0.080 inches. The applied coating would typically be applied thicker than this, and then machined down to the desired thickness.

With the wear resistant materials bonded to the turbine blade, the next step 504 is to perform a hot isostatic pressing on the coated turbine blade. The Hot Isostatic Pressing (commonly referred to as HIP) is a high temperature, high-pressure process. This process can be employed to fully consolidate the cold-sprayed buildup and eliminate defects like shrinkage and porosity (a common defect related to the cold gas-dynamic spray process). Additionally, this process can strengthen the bonding between the buildup of wear-resistant coating materials and the underlying turbine blade, homogenize chemistries in the applied materials, and rejuvenate microstructures in the base superalloy. Overall mechanical properties such as elevated temperature tensile and stress rupture strengths of the coated gas turbine components can thus be dramatically improved with the hot isostatic pressing.

As one example of hot isostatic pressing parameters, the pressing can be performed for 2 to 4 hours at temperatures of between 2000 and 2300 degrees F. and at pressures of 10 to 30 ksi. Of course, this is just one example of the type of hot isostatic pressing process that can be used to remove defects after the application of wear resistant coating materials.

In some embodiments, it may be desirable to perform a rapid cool following the HIP process to retain the high-temperature solution heat treatment and to minimize the adverse effects of slower cooling rates from HIP temperature. For example, in the case of a nickel based superalloys, rapid cool from the HIP temperature can comprise cooling at a rate of about 45 to 60 degrees F. per minute, from the HIP temperature to below 1200 degrees F., which is normally below the age temperature for such alloys. One advantage of the rapid cool capability is that the component alloy is “solution treated condition”, reducing the need for another solution treatment operation. In other words, the HIP followed by rapid cool can provide a combination of densification, homogenization and solution treat operation. Using this technique can thus eliminate the need for other heat treatment operations.

The next step 506 is to perform a heat treatment on the coated turbine blade. The heat treatment can provide a full restoration of the elevated-temperature properties of turbine blade. As one example, a three-stage heat treatment can be applied. Specifically, a coated turbine blade can be solution heat heated for 2 to 4 hours at temperature of between 2000 to 2200 degrees F., an intermediate treatment of 2 to 4 hours at 1900 to 2000 degrees F., followed by the age treatment of 10-24 hours at between 1300 to 1800 degrees F. As another preferred embodiment, the coated turbine blade can be heated for 2 hours at temperature of 2050 degrees F., followed by 2-4 hours at 1950 degrees for diffusion and environmental protection coating heat treatment, and 10-24 hours at 1550 degrees F. for the age heat treatment. It should be noted that in some applications it may be desirable to delete the high temperature solution treatment if such operation can be accomplished in steps 504.

It should also be noted that in some cases additional processing will be desirable. For example, as stated above in some applications it will be desirable to machine the applied wear resistant coating to achieve a desirable and/or more uniform thickness. As one example, the wear resistant coating can be applied to form a wear resistant coating of between 0.010 to 0.220 inches, and then machined to form a final coating of between 0.010 to 0.100 inches. Again, this is just one example of coating thicknesses that can be applied using the cold gas-dynamic spray process.

The present invention thus provides an improved method for increasing the durability of a turbine engine. The method utilizes a cold gas-dynamic spray technique to apply wear resistant materials to turbine blades. These wear resistant materials improve the durability of the turbine blades, and thus can improve the overall durability, reliability and performance of the turbine engine themselves.

The embodiments and examples set forth herein were presented in order to best explain the present invention and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed. Many modifications and variations are possible in light of the above teaching without departing from the spirit of the forthcoming claims.

1. A method for applying a wear resistant coating to a turbine blade, the method comprising the steps of:
cold gas-dynamic spraying powder material to form a wear resistant coating on the turbine blade.

2. The method of claim 1 wherein the powder material comprises Stellite694.

3. The method of claim 1 wherein the powder material comprises Tribaloy800.

4. The method of claim 1 wherein the turbine blade comprises a z-notch shroud, and wherein the wear resistant coating is formed on the z-notch shroud.

5. The method of claim 4 wherein the wear resistant coating is formed on an edge of the z-notch shroud.

6. The method of claim 1 further comprising the step of performing a hot isostatic pressing on the turbine blade after the step of cold gas-dynamic spraying powder material.

7. The method of claim 6 wherein the step of performing a hot isostatic pressing on the turbine blade comprises pressing for between 2 and 4 hours at temperatures of between 2000 and 2300 degrees F. and at pressures of between 10 and 30 ksi.

8. The method of claim 7 further comprising the step of performing a rapid cooling of between 45 and 60 degrees F. per minute to a desired temperature level after the hot isostatic pressing.

9. The method of claim 1 further comprising the step of performing a heat treatment on the turbine blade after the step of cold gas-dynamic spraying powder material.

10. The method of claim 9 wherein the step of performing a heat treatment comprises a heat treatment of between 2 to 4 hours at temperatures of between 2000 and 2200 degrees F. followed by a second heat treatment of between 10 to 24 hours at temperatures of between 1300 and 1800 degrees F.

11. The method of claim 1 wherein the step of cold gas-dynamic spraying particles to form a coating on at least a portion of the turbine blade comprises forming a coating thickness of between 0.010 to 0.220 inches.

12. The method of claim 11 further comprising the step of machining the coating to have a final thickness of between 0.006 to 0.08 inches.

13. A method for applying a wear resistant coating to a turbine blade, the method comprising the steps of:
cold gas-dynamic spraying powder materials to form a coating on at least a portion of the turbine blade;
performing a hot isostatic pressing on the coated turbine blade; and
heat treating the coated turbine blade.

14. The method of claim 13 wherein the powder materials comprise Stellite694.

15. The method of claim 13 wherein the powder materials comprise Tribaloy800.

16. The method of claim 13 wherein the turbine blade comprises a z-notch shroud, and wherein the wear resistant coating is formed on the z-notch shroud.

17. The method of claim 16 wherein the wear resistant coating is formed on an edge of the z-notch shroud.

18. The method of claim 13 wherein the step of performing a hot isostatic pressing on the turbine blade comprises pressing for between 2 and 4 hours at temperatures of between 2000 and 2300 degrees F. and at pressures of between 10 and 30 ksi.

19. The method of claim 18 further comprising the step of performing a rapid cooling of between 45 and 60 degrees F. per minute to a desired temperature level after the hot isostatic pressing.

20. The method of claim 13 wherein the step of performing a heat treatment comprises a heat treatment of between 2 to 4 hours at temperatures of between 2000 and 2200 degrees F. followed by a second heat treatment of between 10 to 24 hours at temperatures of between 1300 and 1800 degrees F.

21. The method of claim 13 wherein the step of cold gas-dynamic spraying particles to form a coating on at least a portion of the turbine blade comprises forming a coating thickness of between 0.010 to 0.220 inches.

22. The method of claim 21 further comprising the step of machining the coating to have a final thickness of between 0.006 to 0.08 inches.

23. A method for applying a wear resistant coating to a z-notch on a turbine blade, the method comprising the steps of:
providing wear resistant powder material;
mixing the wear resistant powder material into a flow of gas, the gas at a temperature below a melting temperature of the wear resistant powder material;
accelerating the wear resistant powder material mixed into the flow of gas; and
directing the accelerated wear resistant powder material to the z-notch on the turbine, wherein the wear resistant powder material deforms on the z-notch to form a coating on the z-notch;
performing a hot isostatic pressing on the turbine blade for between 2 and 4 hours at temperatures of between 2000 and 2300 degrees F. and at pressures of between 10 and 30 ksi; and
heat treating the turbine blade between 2 to 4 hours at temperatures of between 2000 and 2200 degrees F. followed by a second heat treatment of between 10 to 24 hours at temperatures of between 1300 and 1800 degrees F.
